(19) United States
(12) Patent Application Publication
(10) Pub. No.: US 2024/0428620 A1
(43) Pub. Date: Dec. 26, 2024

(54) SYSTEMS AND METHODS FOR RECOGNIZING NON-LINE-OF-SIGHT HUMAN ACTIONS

(71) Applicant: SAMSUNG ELECTRONICS CO., LTD., Suwon-si (KR)

(72) Inventors: Vishakha S R, Bengaluru (IN); Pawan Prasad BINDIGAN HARIPRASANNA, Bengaluru (IN); Green Rosh K S, Bengaluru (IN); Akula JAYAPRAKASH, Bengaluru (IN); Prateek KUKREJA, Bengaluru (IN)

(73) Assignee: SAMSUNG ELECTRONICS CO., LTD., Suwon-si (KR)

(21) Appl. No.: 18/823,150

(22) Filed: Sep. 3, 2024

Related U.S. Application Data
(63) Continuation of application No. PCT/KR2023/004185, filed on Mar. 29, 2023.

(30) Foreign Application Priority Data
May 16, 2022 (IN) 202241028092
Nov. 24, 2022 (IN) 20224 1028092

(51) Int. Cl. G06V 40/20; G06T 3/40; G06T 7/20; G06V 10/74

(52) U.S. Cl. CPC G06V 40/20; G06T 3/40; G06T 7/20; G06V 10/761; G06T 2207/30241

(57) ABSTRACT

Provided are a system and a method for recognizing non-line-of-sight human action, the method including receiving a plurality of image frames in a sequential order from an imaging device, wherein at least one of the plurality of image frames comprises at least one entity performing an action; identifying, based on the plurality of image frames, that a first partial portion of the action occurs within a field of view of the imaging device and a second partial portion of the action occurs outside the field of view of the imaging device; identifying a type of a motion which occurs during the action based on the first partial portion; extrapolating the motion based on the first partial portion, and generating a trajectory of the motion corresponding to the second partial portion of the action; and recognizing the human action from the type of the motion and the trajectory of the motion.

### CROSS-REFERENCE TO RELATED APPLICATIONS

This application is a by-pass continuation of International Application No. PCT/KR2023/004185, filed on Mar. 29, 2023, which is based on and claims priority to Indian patent application Ser. No. 20/224,1028092, filed on May 16, 2022, and Indian patent application Ser. No. 20/224,1028092, filed on Nov. 24, 2022, the disclosures of which are incorporated by reference herein in their entireties.

### BACKGROUND

### 1. Field

The present disclosure relates to image processing, and more particularly, to systems and methods for recognizing non-line-of-sight human actions from a plurality of image frames.

### 2. Description of Related Art

Image-based human action recognition refers to the technology of automatically analyzing human actions based on captured image frames of a single person or a group of people. For example, one particularly useful application of image based human action recognition is for monitoring health and wellness of individuals based on video images captured by surveillance cameras.

However, such conventional techniques for recognizing human action fail to accurately recognize the action when the person is out of the field-of-view (FOV) of the camera. Further, such conventional techniques for recognizing human action are complex and require extensive components.

Accordingly, there is a need to overcome at least the above challenges associated with recognition of human actions from image frames.

### SUMMARY

According to an aspect of the disclosure, a method of recognizing non-line-of-sight human action includes: receiving a plurality of image frames in a sequential order from an imaging device, wherein at least one image frame from the plurality of image frames includes at least one entity performing an action; identifying, based on the plurality of image frames, that a first partial portion of the action occurs within a field of view of the imaging device and a second partial portion of the action occurs outside the field of view of the imaging device; identifying a type of a motion which occurs during the action based on the first partial portion; extrapolating the motion based on the first partial portion, and generating a trajectory of the motion corresponding to the second partial portion of the action; and recognizing the action from the type of the motion and the trajectory of the motion.

The method may further include: identifying a peak frame from the plurality of image frames, wherein the peak frame may include a peak point of the action performed by the at least one entity based on the trajectory; constructing a binary tree of the plurality of image frames, wherein the peak frame may form a root node of the binary tree; and recognizing the action by analyzing the binary tree based on a level order traversal.

One or more of the plurality of image frames received prior to the peak frame may form a first branch of the binary tree and one or more of the plurality of image frames received after the identified peak frame may form a second branch of the binary tree.

The analyzing the binary tree based on the level order traversal may include: reordering the sequential order of the plurality of image frames using the level order traversal; identifying a pattern corresponding to positions of the at least one entity in the reordered plurality of image frames; and comparing the identified pattern with one or more pre-trained patterns to recognize the action performed by the at least one entity.

The method may further include: downscaling the plurality of image frames based on at least one of a power state or resource information of a system, wherein the identifying that the first partial portion of the action occurs within the field of view of the imaging device and that the second partial portion of the action occurs outside the field of view of the imaging device may include analyzing the plurality of downward scaled image frames.

The method may further include: identifying image frames at predetermined intervals among the plurality of image frames based on at least one of a power state or resource information of a system, wherein the identifying that the first partial portion of the action occurs within the field of view of the imaging device and that the second partial portion of the action occurs outside the field of view of the imaging device may include analyzing the image frames identified at predetermined intervals.

According to an aspect of the disclosure, a system for recognizing non-line-of-sight human action includes: at least one memory storing one or more instructions; at least one processor communicably coupled to the at least one memory, wherein the at least one processor is configured to execute the one or more instructions, and wherein the one or more instructions, when executed by the at least one processor, are configured to cause the system to: receive a plurality of image frames in a sequential order from an imaging device, wherein at least one image frame from the plurality of image frames includes at least one entity performing an action, identify, based on the plurality of image frames, that a first partial portion of the action occurs within a field of view of the imaging device and a second partial portion of the action occurs outside the field of view of the imaging device, identify a type of a motion which occurs during the action based on the first partial portion, extrapolate the motion based on the first partial portion, and generate a trajectory of the motion corresponding to the second partial portion of the action, and recognize the human action from the type of the motion and the trajectory of the motion.

The one or more instructions, when executed by the at least one processor, may be further configured to cause the system to: identify a peak frame, from the plurality of image frames, wherein the peak frame may form a peak point of the action performed by the at least one entity based on the trajectory, construct a binary tree of the plurality of image frames, wherein the peak frame may form a root node of the binary tree, and recognize the human action by analyzing the binary tree based a level order traversal.

One or more of the plurality of image frames received prior to the peak frame may form a first branch of the binary tree and one or more of the plurality of image frames received after the peak frame may form a second branch of the binary tree.

The one or more instructions, when executed by the at least one processor, may be further configured to cause the system to: re-order the sequential order of the plurality of image frames using the level order traversal, identify a pattern corresponding to positions of the at least one entity in the reordered plurality of image frames, and compare the identified pattern with one or more pre-trained patterns to recognize the human action performed by the at least one entity.

The one or more instructions, when executed by the at least one processor, may be further configured to cause the system to: downscale the plurality of image frames based on at least one of a power state or resource information of the system, and identify that the first partial portion of the action occurs within the field of view of the imaging device and that the second partial portion of the action occurs outside the field of view of the imaging device by analyzing the plurality of downward scaled image frames.

The one or more instructions, when executed by the at least one processor, may be further configured to cause the system to: identify image frames at predetermined intervals among the plurality of image frames based on at least one of a power state or resource information of the system, and identify that the first partial portion of the action occurs within the field of view of the imaging device and that the second partial portion of the action occurs outside the field of view of the imaging device by analyzing the image frames identified at predetermined intervals.

According to an aspect of the disclosure, a non-transitory computer readable medium having instructions stored therein, which when executed by at least one processor cause the at least one processor to execute a method of recognizing non-line-of-sight human action, the method including: receiving a plurality of image frames in a sequential order from an imaging device, wherein at least one image frame from the plurality of image frames includes at least one entity performing an action; identifying, based on the plurality of image frames, that a first partial portion of the action occurs within a field of view of the imaging device and a second partial portion of the action occurs outside the field of view of the imaging device; identifying a type of a motion which occurs during the action based on the first partial portion; extrapolating the motion based on the first partial portion, and generating a trajectory of the motion corresponding to the second partial portion of the action; and recognizing the action from the type of the motion and the trajectory of the motion.

With regard to the method executed by the at least one processor based on the instructions stored in the non-transitory computer readable medium, the method may further include: identifying a peak frame from the plurality of image frames, wherein the peak frame may form a peak point of the action performed by the at least one entity based on the trajectory; constructing a binary tree of the plurality of image frames, wherein the peak frame may form a root node of the binary tree; and recognizing the action by analyzing the binary tree based on a level order traversal.

With regard to the method executed by the at least one processor based on the instructions stored in the non-transitory computer readable medium, one or more of the plurality of image frames received prior to the peak frame may form a first branch of the binary tree and one or more of the plurality of image frames received after the identified peak frame may form a second branch of the binary tree.

With regard to the method executed by the at least one processor based on the instructions stored in the non-transitory computer readable medium, the analyzing the binary tree based on the level order traversal may include: reordering the sequential order of the plurality of image frames using the level order traversal; identifying a pattern corresponding to positions of the at least one entity in the reordered plurality of image frames; and comparing the identified pattern with one or more pre-trained patterns to recognize the action performed by the at least one entity.

With regard to the method executed by the at least one processor based on the instructions stored in the non-transitory computer readable medium, the method may further include: downscaling the plurality of image frames based on at least one of a power state or resource information of a system, wherein the identifying that the first partial portion of the action occurs within the field of view of the imaging device and that the second partial portion of the action occurs outside the field of view of the imaging device may include analyzing the plurality of downward scaled image frames.

With regard to the method executed by the at least one processor based on the instructions stored in the non-transitory computer readable medium, the method may further include: identifying image frames at predetermined intervals among the plurality of image frames based on at least one of a power state or resource information of a system, wherein the identifying that the first partial portion of the action occurs within the field of view of the imaging device and that the second partial portion of the action occurs outside the field of view of the imaging device may include analyzing the image frames identified at predetermined intervals.

According to an aspect of the disclosure, a method of recognizing non-line-of-sight human action includes: receiving a plurality of image frames in an order from an imaging device, wherein at least one image frame from the plurality of image frames includes at least one entity performing an action; identifying, based on the plurality of image frames, that a first partial portion of the action occurs within a field of view of the imaging device and a second partial portion of the action occurs outside the field of view of the imaging device; identifying a motion which occurs during the action based on the first partial portion; extrapolating the motion based on the first partial portion, and generating a trajectory of the motion corresponding to the second partial portion of the action; and recognizing the action from the motion and the trajectory of the motion.

According to one embodiment of the present disclosure, a method for recognizing non-line-of-sight human action is disclosed. The method includes receiving a plurality of image frames in a sequential order from an imaging device. At least one image frame from the plurality of image frames comprises at least one entity performing an action. The method also includes analyzing the plurality of image frames to determine that a first partial portion of the action occurs within a field of view of the imaging device and a second partial portion of the action occurs outside the field of view of the imaging device. Further, the method includes identifying a type of motion during the action based on the first partial portion. Moreover, the method includes extrapolating the motion to generate a trajectory of motion corresponding to the second partial portion of the action. Furthermore, the method includes recognizing the action from the type of motion and the generated trajectory of the motion.

According to another embodiment of the present disclosure, a method for recognizing non-line-of-sight human action is disclosed. The method includes receiving a plurality of image frames in a sequential order from an imaging device. At least one image frame from the plurality of image frames comprises at least one entity performing an action. The method also includes identifying a peak frame, from the plurality of image frames, comprising a peak point of the action performed by the at least one entity. The method further includes constructing a binary tree of the plurality of image frames having the identified peak frame as a root node. Moreover, the method includes recognizing the human action by analyzing the constructed binary tree in a level order traversal.

According to yet another embodiment of the present disclosure, a system for recognizing non-line-of-sight human action is disclosed. The system includes a memory and at least one processor. The at least one processor is communicably coupled to the memory. The at least one processor is configured to receive a plurality of image frames in a sequential order from an imaging device. At least one image frame from the plurality of image frames comprises at least one entity performing an action. The at least one processor is also configured to analyze the plurality of image frames to determine that a first partial portion of the action occurs within a field of view of the imaging device and a second partial portion of the action occurs outside the field of view of the imaging device. Further, the at least one processor is configured to identify a type of motion during the action based on the first partial portion. Moreover, the at least one processor is configured to extrapolate the motion to generate a trajectory of motion corresponding to the second partial portion of the action. Furthermore, the at least one processor is configured to recognize the action from the type of motion and the generated trajectory of the motion.

According to yet another embodiment of the present disclosure, a system for recognizing non-line-of-sight human action is disclosed. The system includes a memory and at least one processor. The at least one processor is communicably coupled to the memory. The at least one processor is configured to receive a plurality of image frames in a sequential order from an imaging device. At least one image frame from the plurality of image frames comprises at least one entity performing an action. The at least one processor is further configured to identify a peak frame, from the plurality of image frames, comprising a peak point of the action performed by the at least one entity. Further, the at least one processor is configured to construct a binary tree of the plurality of image frames having the identified peak frame as a root node. Moreover, the at least one processor is configured to recognize the human action by analyzing the constructed binary tree in a level order traversal.

To further clarify the features of the disclosure, a more particular description will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

These and other features, aspects, and advantages of certain embodiments of the disclosure will be more apparent from the following detailed description taken in conjunction with the accompanying drawings, in which:

FIG. 1 illustrates a schematic block diagram of a system for recognizing non-line-of-sight human action, according to an embodiment of the present disclosure;

FIG. 2 illustrates a schematic workflow of recognizing non-line-of-sight human action, according to an embodiment of the present disclosure;

FIG. 3 illustrates an exemplary method for recognizing non-line-of-sight human action, according to an embodiment of the present disclosure;

FIG. 4 illustrates an exemplary method for recognizing non-line-of-sight human action, according to another embodiment of the present disclosure;

FIG. 5 illustrates an exemplary process flow of recognizing non-line-of-sight human action, according to an embodiment of the present disclosure; and

FIGS. 6A and 6B illustrate generation of a pattern to recognize human action, according to an embodiment of the present disclosure.

Further, skilled artisans will appreciate that elements in the drawings are illustrated for simplicity and may not have necessarily been drawn to scale. For example, the flow charts illustrate the method in terms of the most prominent operations involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of certain embodiments of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprise”, “comprising”, or any other variations thereof, are intended to cover a non-exclusive inclusion, such that a process or method that comprises a list of steps or operations does not include only those steps or operations but may include other steps or operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the present disclosure are directed towards methods and systems for recognizing non-line-of-sight human actions.

The term “non-line-of-sight human action” used throughout the specification may refer to human action which is performed when the person performing the action is either partially or completely not in a line-of-sight of a camera device capturing the human action either at a start of the action or at an end of the action.

The terms “camera”, “camera device”, and “imaging device” may be used interchangeably throughout the description.

The terms “entity”, “person” and “human” may be used interchangeably throughout the description.

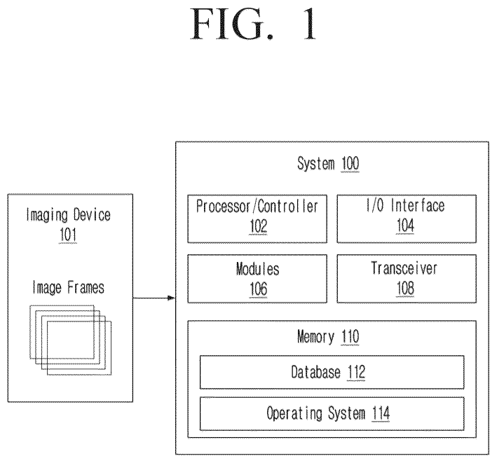

FIG. 1 illustrates a schematic block diagram of a system 100 for recognizing non-line-of-sight human action, according to an embodiment of the present disclosure. In an embodiment, the system 100 may be included within an imaging device 101 associated with a user. Examples of the imaging device 101 may include, but are not limited to, compact cameras, digital cameras, smartphone cameras, mirrorless cameras, video camera, and/or any other image capturing device. In another embodiment, the system 100 may be configured to operate as a standalone device or a system based in a server/cloud architecture communicably coupled to the imaging device 101.

The system 100 may be configured to receive and process a plurality of image frames captured by the imaging device 101 to recognize a human action. The system 100 may include a processor/controller 102, an Input/Output (I/O) interface 104, one or more modules 106, a transceiver 108, and a memory 110.

In an exemplary embodiment, the processor/controller 102 may be operatively coupled to each of the I/O interface 104, the modules 106, the transceiver 108 and the memory 110. In an embodiment, the processor/controller 102 may include at least one data processor for executing processes in Virtual Storage Area Network. The processor/controller 102 may include specialized processing units such as integrated system (bus) controllers, memory management control units, floating point units, graphics processing units, digital signal processing units, etc. In an embodiment, the processor/controller 102 may include a central processing unit (CPU), a graphics processing unit (GPU), or both. The processor/controller 102 may be one or more general processors, digital signal processors, application-specific integrated circuits, field-programmable gate arrays, servers, networks, digital circuits, analog circuits, combinations thereof, or other now known or later developed devices for analyzing and processing data. The processor/controller 102 may execute a software program, such as code generated manually (i.e., programmed) to perform the desired operation.

The processor/controller 102 may be disposed in communication with one or more input/output (I/O) devices via the I/O interface 104. The I/O interface 104 may employ communication code-division multiple access (CDMA), high-speed packet access (HSPA+), global system for mobile communications (GSM), long-term evolution (LTE), WiMAX, or the like, etc.

Using the I/O interface 104, the system 100 may communicate with one or more I/O devices such as imaging devices used for capturing the plurality of image frames. Other examples of the input device may be an antenna, microphone, touch screen, touchpad, storage device, transceiver, video device/source, etc. The output devices may be a printer, fax machine, video display (e.g., cathode ray tube (CRT), liquid crystal display (LCD), light-emitting diode (LED), plasma, Plasma Display Panel (PDP), Organic light-emitting diode display (OLED) or the like), audio speaker, etc. In an embodiment, the I/O interface 104 may enable input and output to and from the system 100 using suitable devices such as, but not limited to, display, keyboard, mouse, touch screen, microphone, speaker and so forth.

The processor/controller 102 may be disposed in communication with a communication network via a network interface. In an embodiment, the network interface may be the I/O interface 104. The network interface may connect to the communication network to enable connection of the system 100 with the outside environment and/or device/system. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the system 100 may communicate with other devices. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

In an exemplary embodiment, the processor/controller 102 may be configured to receive the plurality of frames from the imaging device 101. The processor/controller 102 may execute a set of instructions on the received frames to recognize the human action. In an exemplary embodiment, the processor/controller 102 may receive the plurality of image frames in a sequential order, where at least one image frame from the plurality of image frames comprises at least one entity performing an action. Here, the entity may refer to a person/human performing the action. In an embodiment, the plurality of image frames may correspond to a video of the action. The processor/controller 102 may also be configured to analyze the plurality of image frames to determine that a first partial portion of the action occurs within a Field of View (FOV) of the imaging device 101 and a second partial portion of the action occurs outside the field of view of the imaging device. For example, in a case where the image frames correspond to jump action, the processor/controller 102 may identify that a starting portion up through the person reaching a maximum height (during the jump) occurs within the FOV, while the ending portion (i.e., after the maximum height of the jump is reached) occurs outside the FOV of the imaging device 101, or vice versa.

Further, the processor/controller 102 may be configured to identify a type of motion during the action based on a first partial portion. For example, in the jump action scenario, the processor/controller 102 may identify that the person is going upwards in the first partial portion of the action. Thereafter, the processor/controller 102 may be configured to extrapolate the motion to generate a trajectory of motion corresponding to a second partial portion of the action. For example, in the jump action scenario, the processor/controller 102 may be configured to extrapolate the motion as the person comes downwards after reaching the maximum height of the jump in the second partial portion of the action. Based on the extrapolation, the processor/controller may be configured to generate the trajectory of motion. For example, in the jump action scenario, a trajectory similar to an inverse parabolic line drawing may be generated. Here, the processor/controller 102 may identify a user by inputting each of a plurality of frames to a neural network model.

The processor/controller 102 may be configured to identify a peak frame from the plurality of frames. The peak frame may include a peak point (e.g., an inflection point) of the action. For example, in the discussed jump case scenario, the processor/controller 102 may identify a frame as the peak frame where the person performing the action is at the maximum height. In another embodiment, in order to identify the peak frame, the processor/controller 102 may be configured to estimate a plurality of key points associated with the entity from the frames where the entity is in line-of-sight/Field-of-view. The key points may refer to main body parts of the entity including head, hand joints, leg joints, and so forth. Further, the processor/controller 102 may be configured to identify a mean key position corresponding to the entity in each of the frames where the entity is in line-of-sight/Field-of-view. The processor/controller 102 may also be configured to compute a mean key position trajectory using the estimated key points associated with the entity. Further, the processor/controller 102 may be configured to extrapolate the mean key position trajectory for the frames where the entity is out of the line-of-sight/FOV. Thereafter, the processor/controller 102 may be configured to identify the peak frame based on the extrapolated mean key position trajectory. In an embodiment, the processor/controller 102 may be configured to identify a deviation in the mean key position trajectory in order to determine the peak frame. The deviation may include a change in direction of the mean key position trajectory or a change in speed of the mean key position trajectory. For example, for the jump action scenario, the mean key position trajectory may move upward for some time, and then move downward. Therefore, the processor/controller 102 may be configured to consider the frame where the direction of the mean key position trajectory changes from upward to downward, as the peak frame. Here, the processor/controller 102 may input each of a plurality of frames to a neural network model to identify a user's key point, and may identify a peak frame based on the plurality of the user's key points.

The processor/controller 102 may identify a plurality of peak frames from the plurality of frames. For example, when the user jumps twice, the processor/controller 102 determines a peak frame corresponding to an expected peak time of a first jump, a peak frame corresponding to a landing time after the first jump, an expected peak time of a second jump and a peak frame corresponding to a landing time after the second jump.

The processor/controller 102 may be configured to construct a binary tree of the plurality of frames considering the identified peak frame as a root node. In an exemplary embodiment, the frames received/captured prior to the identified peak frame form one branch of the binary tree and the image frame received/captured after the identified peak frame form another branch of the binary tree.

Further, the processor/controller 102 may be configured to re-order the sequential order of the plurality of frames using a level order traversal of the constructed binary tree. The level order traversal may refer to processing of each node of the constructed binary tree by traversing through depth, first the root, and then child of the root, etc. For example, the processor/controller 102 may be configured to traverse through the binary tree of the frames by first processing the peak frame, a frame from a first branch, then a frame from a second branch, and so on.

Furthermore, the processor/controller 102 may be configured to identify a pattern corresponding to positions of the at least one entity in the re-ordered plurality of frames. Thereafter, the processor/controller 102 may be configured to compare the identified pattern with one or more pre-trained patterns to recognize the human action performed by the at least one entity. In an embodiment, the pre-trained patterns may be stored in a database 112 of the memory 110. Thus, the processor/controller 102 may be configured to recognize the human action based on said comparison of the identified pattern with the pre-trained patterns.

The processor/controller 102 may identify part of frames at predetermined intervals among a plurality of frames based on at least one of a power state or resource information of the system 100, and identify an operation of an entity based on the identified frames. Alternatively, the processor/controller 102 downscales a resolution of each of the plurality of frames based on at least one of the power state or resource information of the system 100, and identifies the operation of the entity based on the plurality of downscaled frames.

When a plurality of entities are identified in each of a plurality of frames, the processor/controller 102 may identify one entity based on a size of the plurality of entities and identify an operation of the identified entity. Alternatively, when a plurality of entities are identified in each of a plurality of frames, the processor/controller 102 identifies a type of each of the plurality of entities, identify one entity based on the type of each of the plurality of entities, and identify a behavior of the identified entity.

In one or more embodiments, the memory 110 may be communicatively coupled to the at least one processor/controller 102. The memory 110 may be configured to store data, instructions executable by the at least one processor/controller 102. In an embodiment, the memory 110 may communicate via a bus within the system 100. The memory 110 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 110 may include a cache or random access memory for the processor/controller 102. In alternative examples, the memory 110 is separate from the processor/controller 102, such as a cache memory of a processor, the system memory, or other memory. The memory 110 may be an external storage device or database for storing data. The memory 110 may be operable to store instructions executable by the processor/controller 102. The functions, acts or tasks illustrated in the figures or described may be performed by the programmed processor/controller 102 for executing the instructions stored in the memory 110. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

In one or more embodiments, the modules 106 may be included within the memory 110. The one or more modules 106 may include a set of instructions that may be executed to cause the system 100 to perform any one or more of the methods/processes disclosed herein. In one or more embodiments, the modules 106 may be configured to perform one or more operations of the processor/controller 102. The one or more modules 106 may be configured to perform the operations of the present disclosure using the data stored in the database 112 to recognize the human action as discussed herein. In an embodiment, each of the one or more modules 106 may be a hardware unit which may be outside the memory 110. Further, the memory 110 may include an operating system 114 for performing one or more tasks of the system 100, as performed by a generic operating system in the communications domain. The transceiver 108 may be configured to receive and/or transmit signals to and from the imaging device 101 associated with the user. In an embodiment, the database 112 may be configured to store the information as required by the one or more modules 106 and the processor/controller 102 to perform one or more functions for recognizing the human action from the image frames.

Further, the present disclosure contemplates a computer-readable medium that includes instructions or receives and executes instructions responsive to a propagated signal. Further, the instructions may be transmitted or received over the network via a communication port or interface or using a bus. The communication port or interface may be a part of the processor/controller 102 or may be a separate component. The communication port may be created in software or may be a physical connection in hardware. The communication port may be configured to connect with a network, external media, the display, or any other components in system, or combinations thereof. The connection with the network may be a physical connection, such as a wired Ethernet connection or may be established wirelessly. Likewise, the additional connections with other components of the system 100 may be physical or may be established wirelessly. The network may alternatively be directly connected to the bus. For the sake of brevity, the architecture, and standard operations of the operating system 114, the memory 110, the database 112, the processor/controller 102, the transceiver 108, and the I/O interface 104 are not discussed in detail.

The function related to the artificial intelligence according to an embodiment is operated through the processor/controller 102 and the memory 110.

The processor/controller 102 may consist of one processor or a plurality of processors. In this case, the one or the plurality of processors may be a general-purpose processor such as Central Processing Unit (CPU), Application Processor (AP), Digital Signal Processor (DSP), etc., a graphics-only processor such as Graphics Processing Unit (GPU) and Vision Processing Unit (VPU), or an artificial intelligence-only processor such as Neural Processing Unit (NPU).

One or a plurality of processors process input data according to a predefined operation rule stored in a memory or an artificial intelligence model. Alternatively, if one or a plurality of processors are AI-only processors, the AI-only processors may be designed in a hardware structure specialized for processing a specific artificial intelligence model. The predefined operation rule or the artificial intelligence model is characterized by being created through learning.

Here, being “created through learning” means creating a predefined operation rule or an artificial intelligence model that is set to perform a desired characteristic (or purpose) as a basic artificial intelligence model is trained by a learning algorithm using a plurality of learning data. Such learning may be conducted in an apparatus itself where artificial intelligence according to an embodiment is performed, or may be conducted through a separate server and/or system. The examples of the learning algorithm include supervised learning, unsupervised learning, semi-supervised learning or reinforcement learning, but are not limited thereto.

The artificial intelligence model may be composed of a plurality of neural network layers. Each of the plurality of neural network layers has a plurality of weight values, and performs a neural network operation through operation between a result of operation of the previous layer and the plurality of weight values. The plurality of weight values of the plurality of neural network layers may be optimized by a learning result of the artificial intelligence model. For example, the plurality of weight values may be updated so that a loss value or a cost value obtained from the artificial intelligence model during the learning process is reduced or minimized.

The artificial neural network may include a Deep Neural Network (DNN) and for example, may be a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), a Deep Q-Networks, etc. However, the artificial neural network is not limited to the above-mentioned examples.

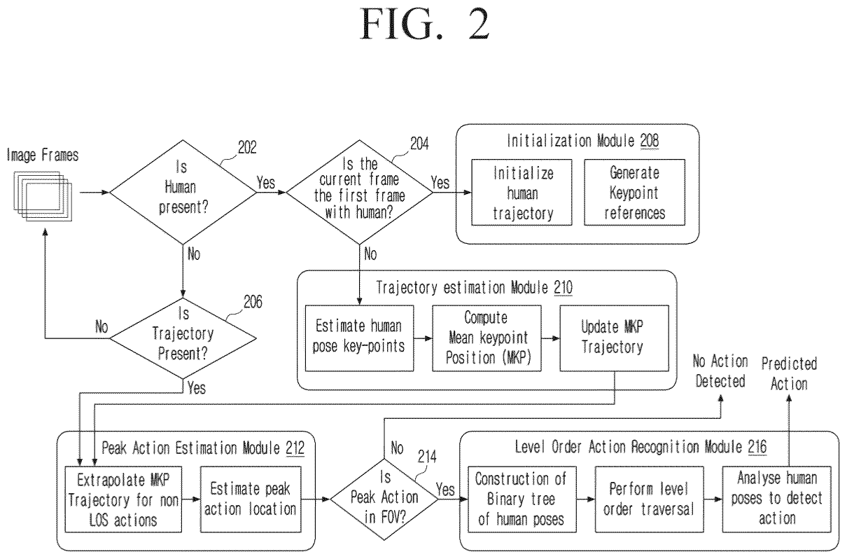

FIG. 2 illustrates a schematic workflow of recognizing non-line-of-sight human action using a plurality of image frames (interchangeably referred to as “frames”), according to an embodiment of the present disclosure. FIG. 2 may be explained in conjunction with FIG. 1.

Block 202 may represent determination of presence of a human in the image frames. Specifically, at block 202, the system 100 may process the frames to determine whether the human is present or not. When the system 100 determines a presence of a human, the workflow moves to block 204. However, when the system 100 determines that no human is present in the frame, the workflow moves to block 206.

Block 204 may represent determination of a first frame where the human is present. Specifically, the system 100 may determine whether a current frame is the first frame with the human or not. In a case where the current frame is the first frame with the human, the workflow moves to block 208. However, in a case where the current frame is not the first frame with the human, the workflow moves to block 210.

Block 206 may present determination of the presence of a trajectory. The system 100 may identify whether there is a detectible trajectory present or not. In a case where the system 100 identifies a trajectory, the workflow moves to block 212. However, in a case where the system 100 fails to identify a trajectory, the workflow moves back to the image frames. Thus, in a case where there is no trajectory, the block 206 may form a closed loop with block 202.

Block 208 may represent an initialization module. The initialization module 208 may be a part of the modules 106, shown in FIG. 1. The initialization module 208 may be activated at a first instance when the human is detected in the frames. Specifically, the initialization module 208 may be activated when the system 100 determines that the current frame is the first frame with a human. The initialization module 208 may be configured to initialize the identification of the human's trajectory. In an embodiment, the initialization module 208 may be configured to mark a starting point of the human trajectory. Further, the initialization module 208 may be configured to generate key points references corresponding to the identified human in the frame. The key points may correspond to body parts and/or joints of the human.

Block 210 may represent a trajectory estimation module. The trajectory estimation module 210 may be a part of the modules 106, shown in FIG. 1. The trajectory estimation module 210 may be activated when the system 100 determines that the current frame includes the human, and the current frame is not the first frame with human. In such a scenario, the trajectory estimation module 210 may be configured to estimate human-pose key points. In an embodiment, the human-pose key points may be determined based on key point references generated by the initialization module 208. The trajectory estimation module 210 may be configured to compute mean key position positions based on the human-pose key points. The key point may be a single point representation of a position of the human in the frame. Thereafter, the trajectory estimation module 210 may be configured to generate/update the Mean Key Position (MKP) trajectory. The trajectory estimation module 210 may also be configured to pass the generated MKP trajectory to block 212. Also at block 206, when the system 100 determines that a trajectory is present, the workflow moves to block 212.

Block 212 may represent a peak action estimation module. The peak action estimation module 212 may be a part of the modules 106, shown in FIG. 1. The peak action estimation module 212 may be configured to extrapolate the MKP trajectory for the frames when the human is not in Line of Sight (LoS)/Field of View (FoV). Further, based on the extrapolated MKP trajectory, the peak action estimation module 212 may be configured to estimate a peak action and corresponding image frame.

Block 214 may represent determination of the presence of peak action in the FOV. Specifically, the system 100 may determine whether the peak action is in the FOV or not. In a case where the system 100 determines that the peak action is in FOV, the workflow moves to block 216. However, in a case where the system 100 determines that the peak action is not in FOV, the workflow may not detect any action.

Block 216 may represent a level order action recognition module. The level order action recognition module 216 (also referred as “the module 216”) may be a part of the modules 106, shown in FIG. 1. The module 216 may be configured to construct a binary tree of the frames considering the peak frame as root node. Further, the module 216 may be configured to perform level order traversal of the constructed binary tree. The module 216 may also be configured to analyze the human poses after re-ordering the frames based on the level order traversal to detect the human action.

The various blocks illustrated in FIG. 2 are exemplary in nature. Embodiments intent to include or otherwise covers any additional block or sequence based on the requirements.

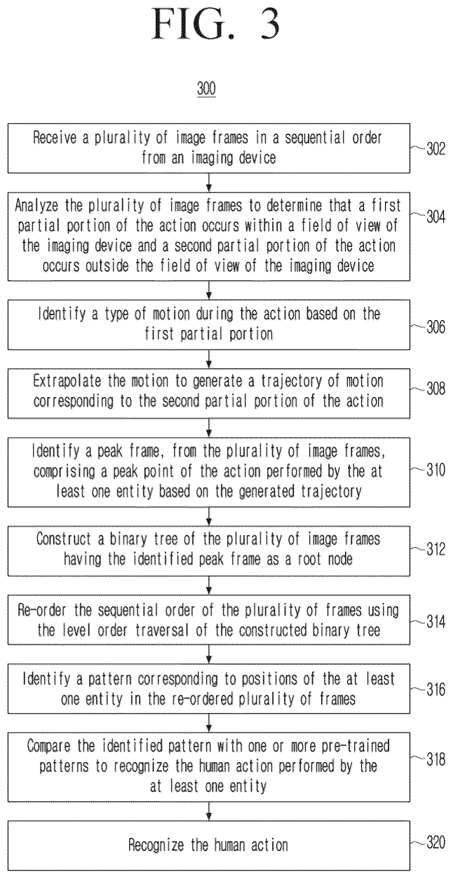

FIG. 3 illustrates an exemplary process of a method 300 for recognizing non-line-of-sight human action, according to an embodiment of the present disclosure.

At operation 302, the method 300 includes receiving a plurality of image frames in a sequential order from an imaging device. The plurality of image frames may be captured by the imaging device 101 and includes an entity performing an action. The entity may refer to a human/person. However, in one or more embodiments, the entity may also include other living being includes animals such as, dog, cat, and so forth. Examples of actions may include, but not limited, running, jumping, squats, pushups, pull-ups, or any other physical activity.

Next at operation 304, the method 300 includes analyzing the plurality of image frames to determine that a first partial portion of the action occurs within a field of view of the imaging device 101 and a second partial portion of the action occurs outside the field of view of the imaging device 101.

At operation 306, the method 300 includes identifying a type of motion during the action based on the first partial portion. For example, the type of motion may indicate that initially the entity is moving upwards, and the entity is coming downwards after a certain point.

Further at operation 308, the method 300 includes extrapolating the motion to generate a trajectory of motion corresponding to the second partial portion of the action. At operation 310, the method 300 includes identifying a peak frame, from the plurality of image frames, comprising a peak point of the action performed by the at least one entity based on the generated trajectory.

At operation 312, the method 300 includes constructing a binary tree of the plurality of image frames having the identified peak frame as a root node. In an embodiment, the frames received/captured prior to the identified peak frame form one branch of the binary tree and other image frame received/captured after the identified peak frame form another branch of the binary tree. Next at operation 314, the method 300 includes re-ordering the sequential order of the plurality of frames using the level order traversal of the constructed binary tree.

At operation 316, the method 300 includes identifying a pattern corresponding to positions of the at least one entity in the re-ordered plurality of frames. The pattern may represent a geometrical figure such as, but not limited to, a line, a parabola, an angle and so forth.

At operation 318, the method 300 includes comparing the identified pattern with one or more pre-trained patterns to recognize the human action performed by the at least one entity. In an embodiment, the memory 110 may store information regarding a relationship of the pre-trained pattern and corresponding action. Further, the system 100 may be configured to utilize the stored relationship to recognize the human action based on the comparison of the identified pattern and the pre-trained patterns. Lastly at operation 320, the method 300 includes recognizing (i.e., identifying) the human action.

Embodiments as discussed above are exemplary in nature and the method 300 may include any additional operation or omit any of above-mentioned operations to perform the desired objective of the present disclosure. Further, the operations of the method 300 may be performed in any suitable order in order to achieve the desired advantages.

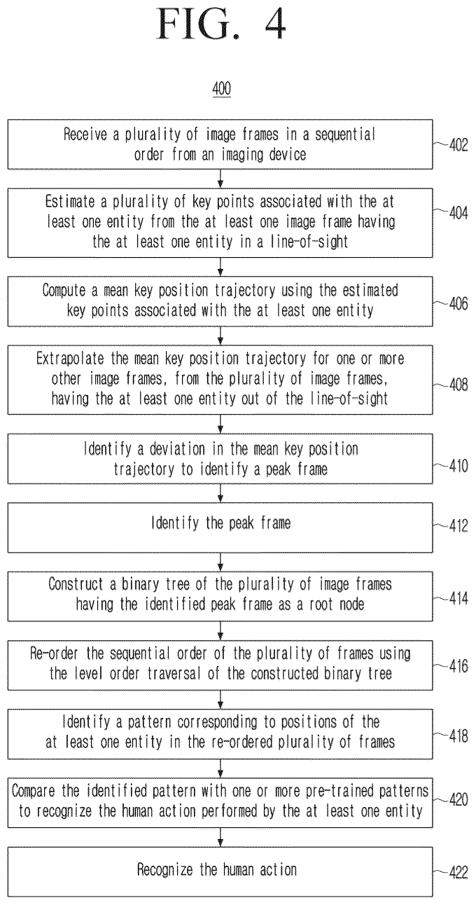

FIG. 4 illustrates another exemplary process of a method 400 for recognizing non-line-of-sight human action, according to an embodiment of the present disclosure.

At operation 402, the method 400 includes receiving a plurality of image frames in a sequential order from an imaging device.

Next at operation 404, the method 400 includes estimating a plurality of key points associated with the at least one entity from the at least one image frame having the at least one entity in a line-of-sight. Here, the processor/controller 102 may use key points identified as larger than or equal to a predetermined size among a plurality of key points associated with an entity. For example, the processor/controller 102 may use a user's head, palm, knee, etc. identified as having a predetermined size or larger in each of a plurality of frames as key points.

Further at operation 406, the method 400 includes computing a mean key position trajectory using the estimated key points associated with the at least one entity.

At operation 408, the method 400 includes extrapolating the mean key position trajectory for one or more other image frames, from the plurality of image frames, having the at least one entity out of the line-of-sight.

At operation 410, the method 400 includes identifying a deviation in the mean key position trajectory to identify a peak frame. In an embodiment, the deviation in the mean key position trajectory may include, but is not limited to, a change in direction of the mean key position trajectory or a change in speed of the mean key position trajectory. Next at operation 412, the method 400 includes identifying the peak frame.

At operation 414, the method 400 includes constructing a binary tree of the plurality of image frames having the identified peak frame as a root node. Further at operation 416, the method 400 includes re-ordering the sequential order of the plurality of frames using the level order traversal of the constructed binary tree.

At operation 418, the method 400 includes identifying a pattern corresponding to positions of the at least one entity in the re-ordered plurality of frames. Next at operation 420, the method 400 includes comparing the identified pattern with one or more pre-trained patterns to recognize the human action performed by the at least one entity. At operation 422, the method 400 includes recognizing the human action.

Embodiments as discussed above are exemplary in nature and the method 400 may include any additional operation or omit any of above-mentioned operations to perform the desired objective of the present disclosure. Further, the operations of the method 400 may be performed in any suitable order in order to achieve the desired outcome.

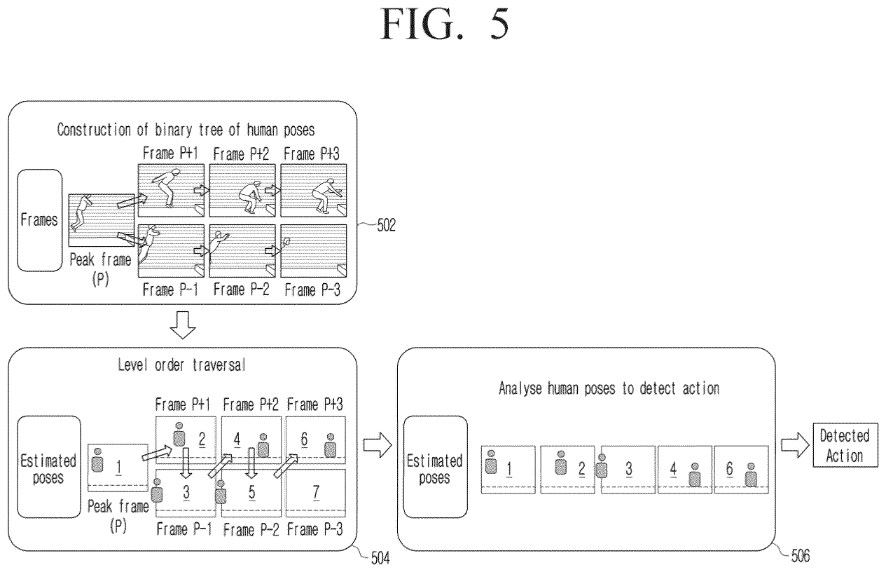

FIG. 5 illustrates an exemplary process flow of recognizing non-line-of-sight human action, according to an embodiment of the present disclosure. FIG. 5 may be explained in conjunction with FIG. 1.

Block 502 may represent generation of a binary tree of human poses in a plurality of frames from “P−3” to “P+3”. Here, a sequential order of the image frames may be defined as “P−3, P−2, P−1, P, P+1, P+2 and P+3”. The system 100 may determine frame “P” as the peak frame and consider the peak frame P as root node of a binary tree. Further, the system 100 may consider all the frames (P+1, P+2, P+3) captured/received after the peak frame “P” to form one branch of the binary tree and consider all the frames (P−1, P−2, P−3) captured/received prior to the peak frame “P” to form another branch of the binary tree, as illustrated in FIG. 5.

Block 504 may represent analysis of the binary tree using the level order traversal. The system 100 may traverse through the depth of the binary tree, starting from peak frame and sequentially moving to each frame of the branches of the binary tree. An order in which the system 100 may traverse through the binary tree has been highlighted by the reference numbers 1-7. For example, the system 100 may first process peak frame “P” also annotated with reference number “1”. Then, the system 100 may process “P+1” frame as also annotated with reference number “2”. The system 100 may process each frame in the binary tree in accordance with annotated reference number.

Block 506 may represent analysis of human poses to detect human action. The system 100 may ignore the frames when the human is not in FOV/LOS. Therefore, the system 100 may only consider frames “P”, “P+1”, “P-1”, “P+2” and “P+3” and may ignore the frames “P−2” and “P−3”, to recognize the human action. Based on the re-ordering of frames where human is in FOV and/or LOS, the system may detect the human action.

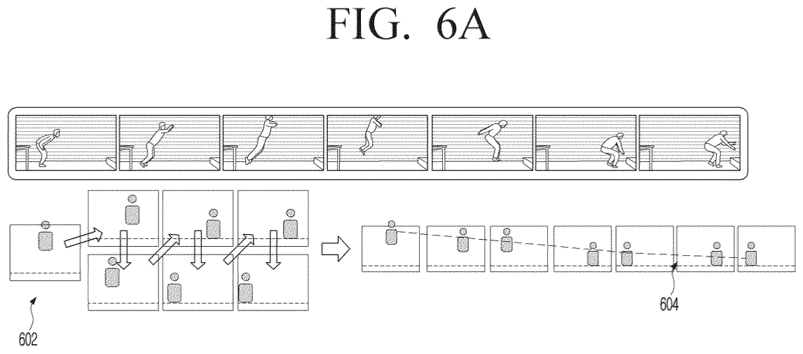

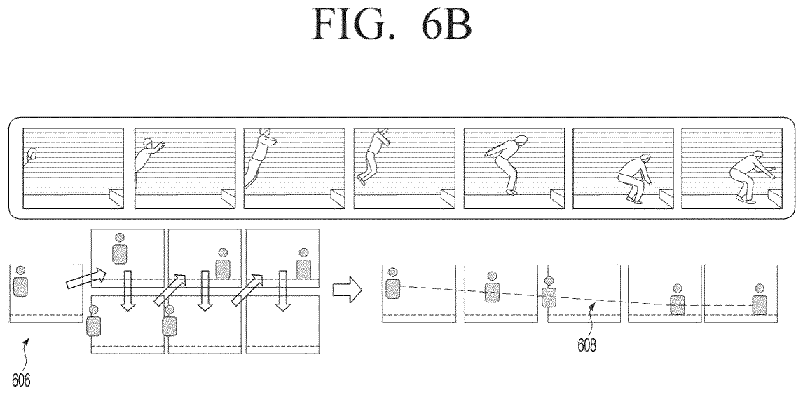

FIGS. 6A and 6B illustrate line-of-sight human action recognition and non-line-of-sight human action recognition, respectively, according to an embodiment of the present disclosure.

FIGS. 6A and 6B also illustrate generation of a pattern to recognize human action, according to an embodiment of the present disclosure.

FIG. 6A illustrates a scenario where the person is in FOV of the imaging device 101 while performing the action. In this scenario, the system 100 may generate a binary tree 602, in accordance with the operations explained above. Further, the system 100 may generate a pattern 604 after analyzing the binary tree 602 using a level order traversal technique. The pattern 604 may be a curved line moving in downward direction. FIG. 6B illustrates a scenario when a partial portion of the person is not in FOV of the imaging device 101 while performing the action. Similar to FIG. 6A, the system 100 may generate a binary tree 606 and also generate a pattern 608 after analyzing the binary tree 606 using level order traversal technique. In an exemplary embodiment, the pattern 608 may be similar to the pattern 604, as shown in FIGS. 6A and 6B. The similarity between the patterns 604 and 608 may indicate that the system 100 may accurately identify the human action even in a situation where the person is not wholly in the FOV.

Thus, the system 100 may be used to generate dynamic videos using the captured frames based on the accurate action recognition.

Based on above, the present disclosure enables recognition of human action where image frames contain partial images, or no images of a human due to a lack of line of sight. Further, the present disclosure provides a simple, compact, and accurate technique for recognizing human action. Specifically, the system reorders image frames to enable accurate detection of human action even when human is either partially or completely not in FOV either in image frames at the starting or in image frames in the end.

While specific language has been used to describe the present subject matter, any limitations arising on account thereof are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

What is claimed is:

1. A method of recognizing non-line-of-sight human action, the method comprising:
receiving a plurality of image frames in a sequential order from an imaging device, wherein at least one image frame from the plurality of image frames comprises at least one entity performing an action;
identifying, based on the plurality of image frames, that a first partial portion of the action occurs within a field of view of the imaging device and a second partial portion of the action occurs outside the field of view of the imaging device;
identifying a type of a motion which occurs during the action based on the first partial portion;
extrapolating the motion based on the first partial portion, and generating a trajectory of the motion corresponding to the second partial portion of the action; and
recognizing the action from the type of the motion and the trajectory of the motion.

2. The method of claim 1, further comprising:
identifying a peak frame from the plurality of image frames, wherein the peak frame comprises a peak point of the action performed by the at least one entity based on the trajectory;
constructing a binary tree of the plurality of image frames, wherein the peak frame comprises a root node of the binary tree; and
recognizing the action by analyzing the binary tree based on a level order traversal.

3. The method of claim 2, wherein one or more of the plurality of image frames received prior to the peak frame comprise a first branch of the binary tree and one or more of the plurality of image frames received after the identified peak frame comprise a second branch of the binary tree.

4. The method of claim 2, wherein the analyzing the binary tree based on the level order traversal comprises:
reordering the sequential order of the plurality of image frames using the level order traversal;
identifying a pattern corresponding to positions of the at least one entity in the reordered plurality of image frames; and
comparing the identified pattern with one or more pre-trained patterns to recognize the action performed by the at least one entity.

5. The method of claim 1, further comprising:
downscaling the plurality of image frames based on at least one of a power state or resource information of a system,
wherein the identifying that the first partial portion of the action occurs within the field of view of the imaging device and that the second partial portion of the action occurs outside the field of view of the imaging device comprises analyzing the plurality of downward scaled image frames.

6. The method of claim 1, further comprising:
identifying image frames at predetermined intervals among the plurality of image frames based on at least one of a power state or resource information of a system,
wherein the identifying that the first partial portion of the action occurs within the field of view of the imaging device and that the second partial portion of the action occurs outside the field of view of the imaging device comprises analyzing the image frames identified at predetermined intervals.

7. A system for recognizing non-line-of-sight human action, the system comprising:
at least one memory storing one or more instructions;
at least one processor communicably coupled to the at least one memory, wherein the at least one processor is configured to execute the one or more instructions, and wherein the one or more instructions, when executed by the at least one processor, are configured to cause the system to:
receive a plurality of image frames in a sequential order from an imaging device, wherein at least one image frame from the plurality of image frames comprises at least one entity performing an action,
identify, based on the plurality of image frames, that a first partial portion of the action occurs within a field of view of the imaging device and a second partial portion of the action occurs outside the field of view of the imaging device,
identify a type of a motion which occurs during the action based on the first partial portion,
extrapolate the motion based on the first partial portion, and generate a trajectory of the motion corresponding to the second partial portion of the action, and
recognize the human action from the type of the motion and the trajectory of the motion.

8. The system of claim 7, wherein the one or more instructions, when executed by the at least one processor, are further configured to cause the system to:
identify a peak frame, from the plurality of image frames, wherein the peak frame comprises a peak point of the action performed by the at least one entity based on the trajectory,
construct a binary tree of the plurality of image frames, wherein the peak frame comprises a root node of the binary tree, and
recognize the human action by analyzing the binary tree based a level order traversal.

9. The system of claim 8, wherein one or more of the plurality of image frames received prior to the peak frame comprise a first branch of the binary tree and one or more of the plurality of image frames received after the peak frame comprise a second branch of the binary tree.

10. The system of claim 8, wherein the one or more instructions, when executed by the at least one processor, are further configured to cause the system to:
re-order the sequential order of the plurality of image frames using the level order traversal,
identify a pattern corresponding to positions of the at least one entity in the reordered plurality of image frames, and
compare the identified pattern with one or more pre-trained patterns to recognize the human action performed by the at least one entity.

11. The system of claim 7, wherein the one or more instructions, when executed by the at least one processor, are further configured to cause the system to:
downscale the plurality of image frames based on at least one of a power state or resource information of the system, and
identify that the first partial portion of the action occurs within the field of view of the imaging device and that the second partial portion of the action occurs outside the field of view of the imaging device by analyzing the plurality of downward scaled image frames.

12. The system of claim 7, wherein the one or more instructions, when executed by the at least one processor, are further configured to cause the system to:
identify image frames at predetermined intervals among the plurality of image frames based on at least one of a power state or resource information of the system, and
identify that the first partial portion of the action occurs within the field of view of the imaging device and that the second partial portion of the action occurs outside the field of view of the imaging device by analyzing the image frames identified at predetermined intervals.

13. A non-transitory computer readable medium having instructions stored therein, which when executed by at least one processor cause the at least one processor to execute a method of recognizing non-line-of-sight human action, the method comprising:
receiving a plurality of image frames in a sequential order from an imaging device, wherein at least one image frame from the plurality of image frames comprises at least one entity performing an action;
identifying, based on the plurality of image frames, that a first partial portion of the action occurs within a field of view of the imaging device and a second partial portion of the action occurs outside the field of view of the imaging device;
identifying a type of a motion which occurs during the action based on the first partial portion;
extrapolating the motion based on the first partial portion, and generating a trajectory of the motion corresponding to the second partial portion of the action; and
recognizing the action from the type of the motion and the trajectory of the motion.

14. The non-transitory computer readable medium of claim 13, wherein the method further comprises:
identifying a peak frame from the plurality of image frames, wherein the peak frame comprises a peak point of the action performed by the at least one entity based on the trajectory;
constructing a binary tree of the plurality of image frames, wherein the peak frame comprises a root node of the binary tree; and
recognizing the action by analyzing the binary tree based on a level order traversal.

15. The non-transitory computer readable medium of claim 14, wherein one or more of the plurality of image frames received prior to the peak frame comprise a first branch of the binary tree and one or more of the plurality of image frames received after the identified peak frame comprise a second branch of the binary tree.

16. The non-transitory computer readable medium of claim 14, wherein the analyzing the binary tree based on the level order traversal comprises:
reordering the sequential order of the plurality of image frames using the level order traversal;
identifying a pattern corresponding to positions of the at least one entity in the reordered plurality of image frames; and
comparing the identified pattern with one or more pre-trained patterns to recognize the action performed by the at least one entity.

17. The non-transitory computer readable medium of claim 13, wherein the method further comprises:
downscaling the plurality of image frames based on at least one of a power state or resource information of a system,
wherein the identifying that the first partial portion of the action occurs within the field of view of the imaging device and that the second partial portion of the action occurs outside the field of view of the imaging device comprises analyzing the plurality of downward scaled image frames.

18. The non-transitory computer readable medium of claim 13, wherein the method further comprises:
identifying image frames at predetermined intervals among the plurality of image frames based on at least one of a power state or resource information of a system,
wherein the identifying that the first partial portion of the action occurs within the field of view of the imaging device and that the second partial portion of the action occurs outside the field of view of the imaging device comprises analyzing the image frames identified at predetermined intervals.
